(19) United States
(12) Patent Application Publication
(10) Pub. No.: US 2010/0131992 A1
(43) Pub. Date: May 27, 2010

(54) Delivery of content in video-on-demand system

(75) Inventors: Mitsuhiro Kenmotsu, Kawasaki (JP); Masayuki Uchida, Kawasaki (JP); Yoshitsugu Ono, Kawasaki (JP); Yu Minakuchi, Kawasaki (JP); Takayuki Yamamoto, Kawasaki (JP); Hidenori Takai, Kawasaki (JP); Shigeru Ohmori, Kawasaki (JP); Kimiko Kojima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/591,556

(22) Filed: Nov. 23, 2009

(30) Foreign Application Priority Data
Nov. 27, 2008 (JP) 2008-302592

(51) Int. Cl. H04N 7/173; H04N 5/91

(52) U.S. Cl. 725/90; 370/468; 386/46; 386/E05.003

(57) ABSTRACT

A method of delivering and playing content includes delivering, through first-group channels, an entirety of content at a content bit rate with a time difference between each delivery commencement, delivering, through one or more second-group channels, only a start portion of the content at two or more times the content bit rate, selecting, from the first-group channels and the one or more second-group channels, a channel through which the start portion of the content is received earliest after a view request, followed by receiving and playing the start portion, and selecting, after receiving the start portion through the selected channel that is one of the one or more second-group channels, one of the first-group channels through which the remainder of the content is received for a first time after a start of the reception of the start portion, followed by receiving and playing the remainder of the content.

### CROSS-REFERENCE TO RELATED APPLICATIONS

The present application is based upon and claims the benefit of priority from the prior Japanese Patent Application No. 2008-302592 filed on Nov. 27, 2008, with the Japanese Patent Office, the entire contents of which are incorporated herein by reference.

### FIELD

The disclosures herein generally relate to video-on-demand content delivery and playback methods, transmission apparatuses, and reception apparatuses, and particularly relate to a content delivery and playback method, transmission apparatus, and reception apparatus that shorten a wait time preceding the commencement of viewing.

### BACKGROUND

Video on demand (VOD) is a service that delivers content upon a viewer request, thereby allowing the viewer to view the desired content at a desired time. A video-on-demand system immediately delivers contents such as movies and TV programs requested by viewers. Such a video-on-demand system preferably includes a large volume of digitized contents for satisfying viewer needs, a video server having a sufficient processing capability to immediately search for a particular content for transmission, and a wideband network with a sufficient capacity to smoothly transmit video and audio content data.

An increase in scale results in an increase in the load of the video server and network. However, implementing a system that can cope with such a heavy load is costly. In order to reduce the load of delivery, the same contents may continue to be delivered at slightly different times through plural multicast channels. With this system, viewers view desired contents by selecting a channel that imposes a short wait time.

Such a content delivery system may essentially be different from the idea of the video-on-demand service. However, such a content delivery system provide a service that approximates video on demand, and is thus referred to as “near video on demand (NVOD).

FIGS. 6A and 6B are drawings illustrating examples of content delivery schedules employed by a related-art near-video-on-demand system. In these examples, a content having a length of 120 minutes is delivered. FIG. 6A illustrates an example in which four identical contents are delivered through four channels (1ch through 4ch) with a 30-minute interval between each commencement of the content. In this example, a wait time from a viewer request to the commencement of viewing is 30 minutes at the maximum. In FIG. 6A, encircled 1 through 4 successively designate respective sections of the 120-munite content data in units of 30 minutes, starting from the beginning of the content.

As a method generally employed to shorten a wait time preceding the commencement of viewing, the number of channels for delivering the same contents may be increased. This shortens a difference in commencement time between each channel, thereby reducing a wait time. FIG. 6B illustrates an example in which eight identical contents having a length of 120 minutes are delivered through eight channels (1ch through 8ch) with a 15-minute interval between each commencement of the content.

In the example illustrated in FIG. 6B, a wait time from a viewer request to the commencement of viewing is 15 minutes at the maximum. In this delivery method, shortening a wait time by half requires twice as many delivery channels, which ends up occupying twice as wide a network bandwidth.

In the following, a description will be given of a content delivery procedure performed by a related-art near-video-on-demand system by referring to FIG. 7.

### <1> Registration of Contents

Contents to be delivered are stored in a predetermined directory in a storage apparatus of a video server (A-1), such that a single content is stored as a single file. The file format may be MPEG-2TS, for example.

### <2> Registration of Channel Information

Channel information regarding each channel to be used for content delivery is registered in a management table stored in the storage apparatus of the video server (A-2). FIG. 8A is a drawing illustrating TABLE 1 that is an example of the channel information management table. As illustrated in TABLE 1, a multicast address and port number are registered as channel information separately for each channel that is to be used for content delivery.

### <3> Registration of Delivery Schedule

A delivery schedule of each channel to be used for content delivery is registered in a management table stored in the storage apparatus of the video server (A-3). The delivery schedule includes a commencement time and finish time of content delivery as well as a file name of the content to be delivered, which are specified on a channel-specific basis for each channel that delivers the content. FIG. 8B is a drawing illustrating TABLE 2 that is an example of the delivery schedule information management table.

### <4> Video Delivery

A video delivery unit 71 of the video server illustrated in FIG. 7 retrieves channel information and delivery schedule information (A-4, A-5). The video delivery unit 71 includes an embedded clock unit. When the embedded clock unit indicates that the commencement time specified in the delivery schedule has arrived, the video delivery unit 71 retrieves the content file specified in the delivery schedule (A-6), and delivers the content through the channel specified in the delivery schedule (A-7). Delivery using this channel is performed by using the multicast address or port number assigned to this channel, which is identified by referring to the channel information management table.

At the time of content delivery, the amount of content transmitted in synchronization with clock cycles is adjusted by using the timestamp of the content as a reference (PCR: Program Clock Reference in the case of MPEG2-TS). With this arrangement, the content stream is transmitted in accordance with the network bandwidth.

### <5> Transmission of Program Listing

A schedule transmission unit 72 of the video server retrieves channel information and delivery schedule information (A-8, A-9). The schedule transmission unit 72 generates a program listing indicative of programs to be broadcast, multicast addresses for the respective programs, and broadcast hours of the respective programs, followed by transmitting the program listing to a reception and playback unit 73. A general Web server or the like may be used for such transmission.

### <6> Displaying of Program Listing

The reception and playback unit 73 of the content reception apparatus receives the program listing transmitted from the video server, and displays the program listing for the viewer (i.e., user). The viewer selects a desired channel to be delivered from the program listing (A-11).

### <7> Content Reception and Playback

The reception and playback unit 73 receives content data (e.g., moving picture stream or the like) from the channel selected by the viewer, and plays the content (A-12).

In a near-video-on-demand system, there is a wait time from the viewer request to the commencement of content delivery. In recent years, there has been a demand to shorten a wait time before the commencement of viewing in the near-video-on-demand systems while employing as little resources (i.e., few channels) as possible for the purpose of increasing delivered contents and improving viewer convenience.

Japanese Laid-open Patent Publication No. 9-37228, for example, discloses a near-video-on-demand delivery method which shortens a wait time before the commencement of viewing while utilizing a small amount of resources (i.e., a small number of channels).

It is preferable to shorten a wait time from a view request to commencement of viewing in a near-video-on-demand system which delivers the same contents at different times through plural channels. A general approach to address this issue may be to deliver a larger number of content streams to shorten a time difference between each content stream. However, this approach results in an increase in the number of delivery channels, ending up occupying a wide network bandwidth.

### SUMMARY

According to an aspect of the embodiment, a method of delivering and playing content in a video-on-demand system includes delivering, through first-group channels, an entirety of the content at a delivery rate equal to a moving picture bit rate of the content with a time difference between each delivery commencement, delivering, through one or more second-group channels different from the first-group channels, only a start portion of the content at a delivery rate equal to two or more times the moving picture bit rate of the content, selecting, from the first-group channels and the one or more second-group channels, a channel through which the start portion of the content is received earliest after an occurrence of a view request, followed by receiving and playing the start portion through the selected channel, and selecting, after receiving the start portion through the selected channel that is one of the one or more second-group channels, one of the first-group channels through which a remainder of the content following the start portion is received for a first time after a start of the reception of the start portion, followed by receiving and playing the remainder of the content through the selected one of the first-group channels.

According to another aspect of the embodiment, a transmission apparatus in a video-on-demand system includes a whole-content delivery unit configured to deliver, through first-group channels, an entirety of content at a delivery rate equal to a moving picture bit rate of the content with a time difference between each delivery commencement, and a start portion delivery unit configured to deliver, through one or more second-group channels different from the first-group channels, only a start portion of the content at a delivery rate equal to two or more times the moving picture bit rate of the content.

According to yet another aspect of the embodiment, a reception apparatus in a video-on-demand system includes a start portion reception and playback unit configured to select, from first-group channels and second-group channels, a channel through which a start portion of content is received earliest after an occurrence of a view request, and to receive and play the start portion through the selected channel, the first-group channels delivering an entirety of the content at a delivery rate equal to a moving picture bit rate of the content with a time difference between each delivery commencement, and the second set of one or more channels delivering only the start portion of the content at a delivery rate equal to two or more times the moving picture bit rate of the content, and a remainder reception and playback unit configured to select, after receiving the start portion through the selected channel that is one of the one or more second-group channels, one of the first-group channels through which a remainder of the content following the start portion is received for a first time after a start of the reception of the start portion, and to receive and play the remainder of the content through the selected one of the first-group channels.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating a procedure of delivering contents in a near-video-on-demand system;

FIGS. 2A and 2B are drawings showing examples of management tables for storing content information and content broadcast information;

FIG. 3 is a drawing showing an example of delivering schedule information;

FIGS. 4A and 4B are drawings showing an example of a delivering schedule pattern;

FIG. 5 is a drawing showing an example of the position of reception commencement;

FIGS. 6A and 6B are drawings showing examples of content delivery by a related-art near-video-on-demand system;

FIG. 7 is a drawing illustrating a procedure of delivering contents in a related-art near-video-on-demand system; and

FIGS. 8A and 8B are drawings showing examples of management tables for storing channel information and delivery schedule information.

### DESCRIPTION OF EMBODIMENTS

In the following, embodiments of the present invention will be described with reference to the accompanying drawings.

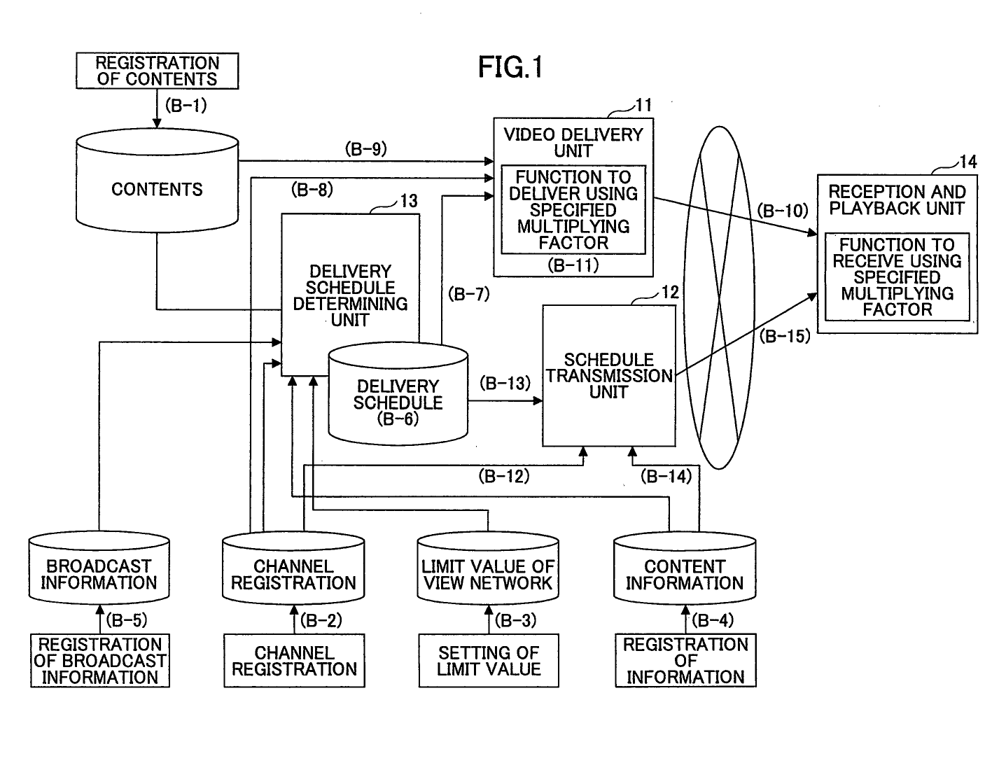

In the following, a description will be given of a content delivery procedure performed by a disclosed near-video-on-demand system by referring to FIG. 1.

### <1> Registration of Contents

Contents to be delivered are stored in a predetermined directory in a storage apparatus of a video server (B-1), such that a single content is stored as a single file. The file format may be MPEG-2TS, for example.

### <2> Registration of Channel Information

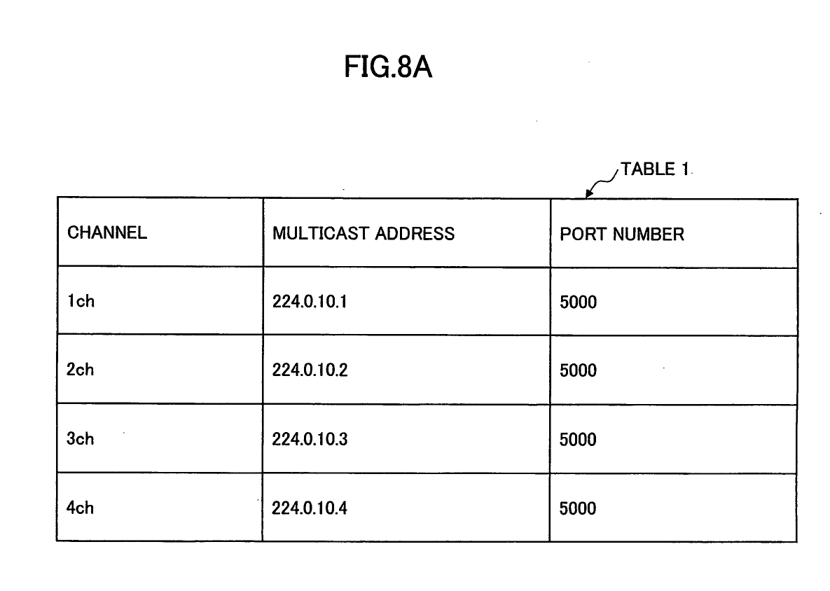

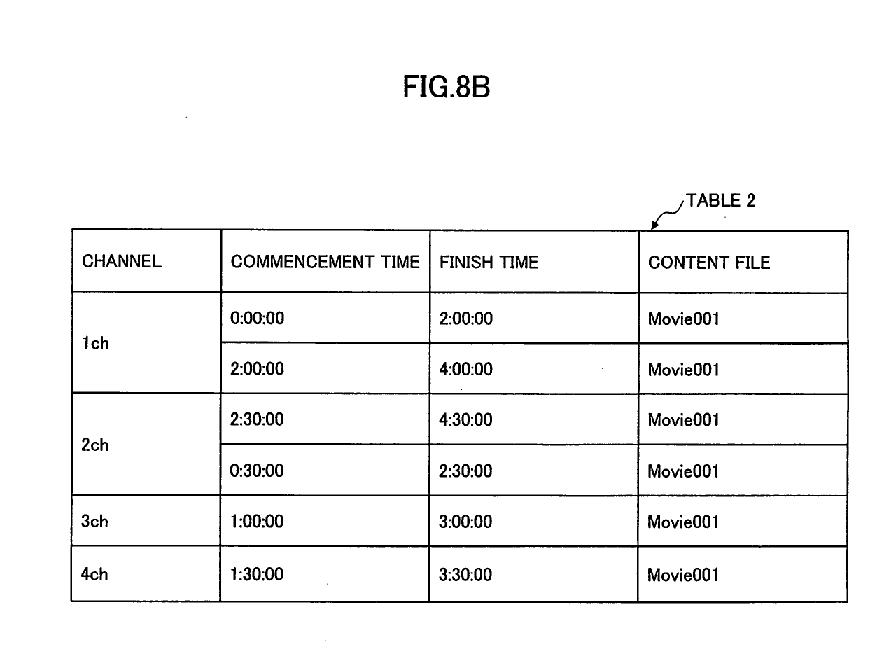

Channel information regarding each channel to be used for content delivery is registered in a management table stored in the storage apparatus of the video server (B-2). The channel information is the same as or similar to the example illustrated in TABLE 1 of FIG. 8A. Namely, a multicast address and port number are registered as channel information separately for each channel that is to be used for content delivery.

### <3> Registration of View Network Limit Value

As information indicative of the performance of a view network for delivering contents, a maximum bandwidth available for transmission per content delivery channel and a reception buffer size of the reception apparatus (i.e., client terminal) are stored as setting data in the storage apparatus of the video server (B-3).

### <4> Registration of Content Information

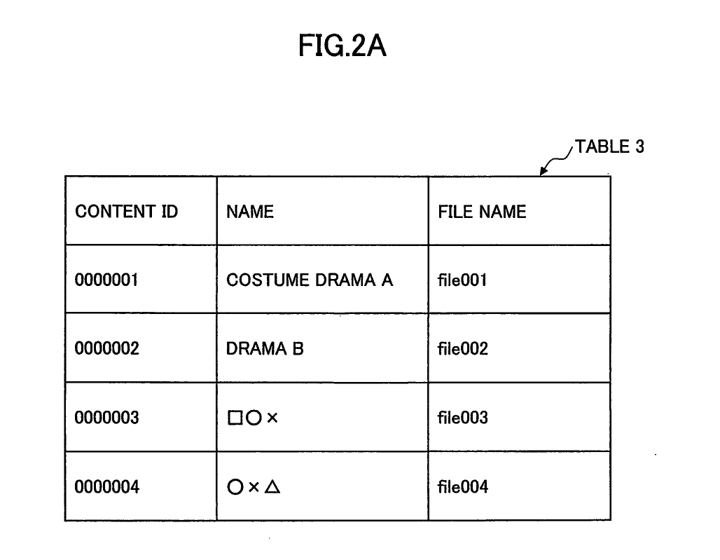

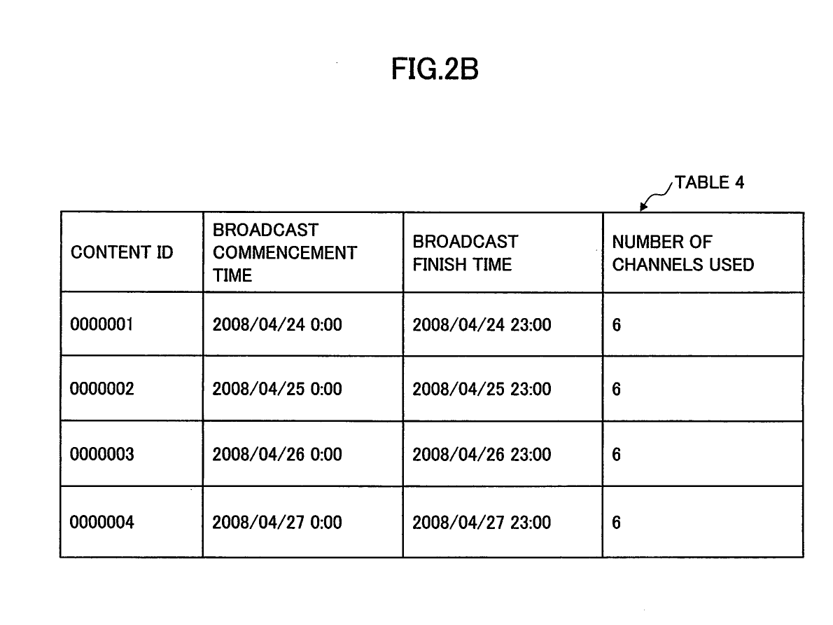

Content information inclusive of a content ID, name, and file name of each content is registered by use of a table format in the storage apparatus of the video server (B-4). FIG. 2A is a drawing illustrating TABLE 3 that is an example of the content information management table.

### <5> Registration of Content Broadcast Information

Content broadcast information inclusive of a content ID, a broadcast commencement time, a broadcast finish time, and a number of used channels with respect to each content is registered by use of a table format in the storage apparatus of the video server (B-5). FIG. 2B is a drawing illustrating TABLE 4 that is an example of the content broadcast information management table. Here, the broadcast commencement time specified in the content broadcast information indicates the time at which the corresponding content starts to be played, and the broadcast finish time indicates the time at which the playing of the corresponding content finishes.

### <6> Creation of Delivery Schedule

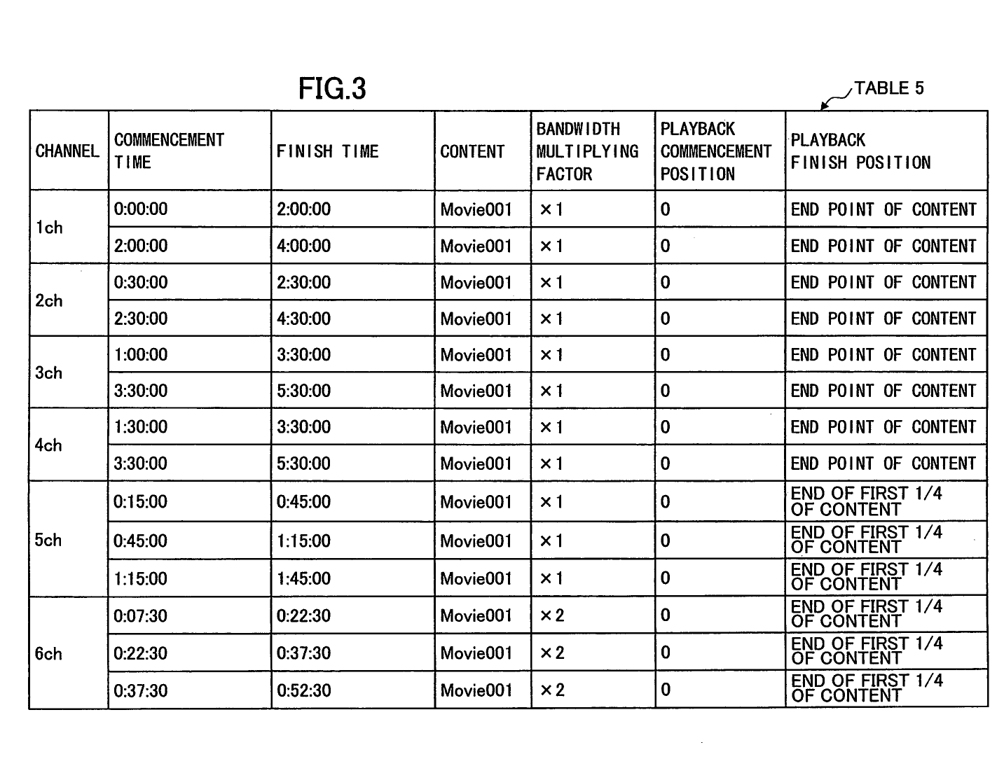

A delivery schedule determining unit 13 of the video server creates a delivery schedule having the following format (B-6). FIG. 3 is a drawing showing TABLE 5 that is an example of delivery schedule information. The delivery schedule information illustrated in this example includes a bandwidth multiplying factor, a playback commencement position, and a playback finish position defined on a delivery-channel-specific basis in addition to the related-art delivery schedule information illustrated in FIG. 8B.

In the following, the creation of a delivery schedule by the delivery schedule determining unit 13 will be described in detail. In this example, a delivery schedule is created under the following conditions:

### (1) Bit Rate of Content Moving Pictures: 1 Mbps;

### (2) Maximum Bandwidth Available for Transmission per View Network Channel: 2 Mbps;

(3) Client Reception Buffer Size: 2 G bytes;
(4) Number of Used Channels: 6 channels; and
(5) Content Length: 120 minutes.

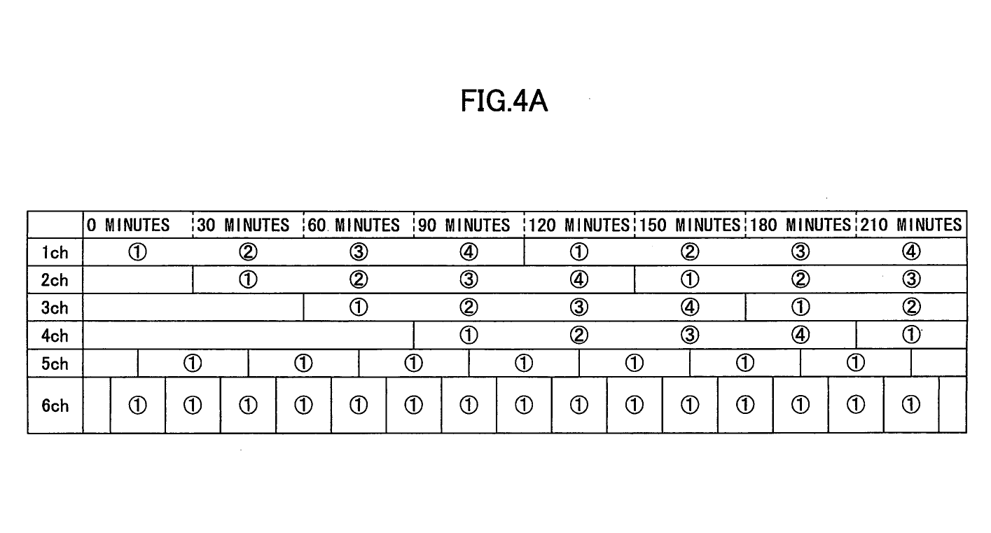

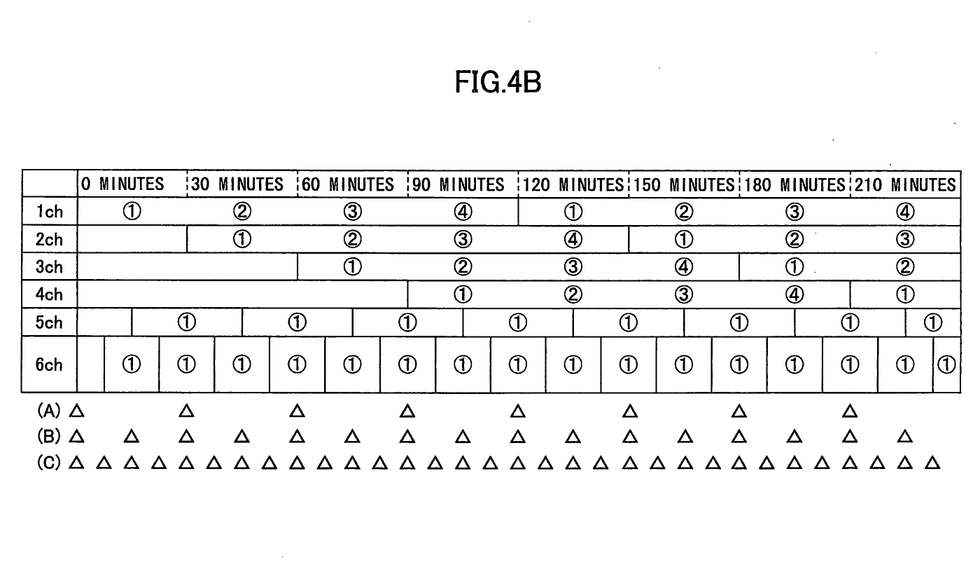

Patterns of created delivery schedules under the above-noted conditions are illustrated in FIG. 4A. As illustrated in FIG. 4A, the first through fourth channels (1ch through 4ch) deliver the entirety of the content with respective 30-minuite time differences, i.e., with a 30-minute time interval between each commencement of delivery. The fifth channel (5ch) delivers a start portion of the content that is equal to the first quarter of the content. The sixth channel (6ch) delivers a start portion of the content that is equal to the first quarter of the content at twice the transmission bandwidth.

### <6.1> Allocation of Delivery Channels to Entirety of Content and Start Portion of Content

In the following, a description will be given of the allocation of channels to the delivery of the entirety of content and to the delivery of a start portion of the content. The number “n” of channels that deliver a start portion is derived as follows.

Namely, a maximum integer n that is no smaller than 0 and satisfies the following condition is obtained.

2ⁿ⁻1×(Bit Rate of Moving Picture)≦Maximum Bandwidth Allowable for Transmission per Channel (1)

If the maximum allowable transmission bandwidth per channel is larger than or equal to the moving picture bit rate of the content, and is smaller than twice the moving picture bit rate, n is equal to 1. If the maximum allowable transmission bandwidth per channel is larger than or equal to twice the moving picture bit rate of the content, and is smaller than four times the moving picture bit rate, n is equal to 2. If the maximum allowable transmission bandwidth per channel is larger than or equal to four times the moving picture bit rate of the content, and is smaller than eight times the moving picture bit rate, n is equal to 3. If the maximum allowable transmission bandwidth per channel is larger than or equal to eight times the moving picture bit rate of the content, and is smaller than sixteen times the moving picture bit rate, n is equal to 4.

In the case of the above-noted conditions for the present embodiment, the maximum allowable transmission bandwidth per channel is equal to twice the moving picture bit rate of the content, so that n is equal to 2. These channels for delivering a start portion correspond to the fifth and sixth channels (i.e., 5ch and 6ch) illustrated in FIG. 4A.

The number “m” of channels that deliver the entirety of the content is derived as follows.

m=Number of Used Channels−n (2)

If the following condition (3) is not satisfied, however, n is decreased until the condition is satisfied. In such a case, m is increased by a number equal to the number of channels decreased in n.

Content Length×Moving Picture Bit Rate/m<Reception Buffer Size (3)

In the case of the present embodiment, n is equal to 2 as derived from the formula (1), and the number of used channels is equal to 6, so that m is equal to 4 according to the formula (2). Then, the left-hand side of the expression (3) is calculated as 120 minutes×60 seconds×1 Mbps/4=1.8 Gbps. 1. 8 Gb is smaller than the client reception buffer size that is 2 Gbyte, which satisfies the condition (3), so that m=4 is acceptable. The first through fourth channels (i.e., 1ch through 4ch) illustrated in FIG. 4A correspond to these channels.

### <6.2> Calculation of Delivery Time Difference Between Channels for Delivering Entirety of Content

A delivery time difference between channels for delivering the entirety of content is calculated by use of the following formula (4). Provision is made such that the first through fourth channels (1ch through 4ch) deliver the entirety of content with the calculated time difference between each delivery start time.

Content Length/m (4)

In the conditions used for the present embodiment, the delivery time difference is equal to 120/4=30 minutes.

### <6.3> Bandwidth Multiplying Factor for Channels for Delivering Start Portion of Content

The n channels for delivering a start portion deliver only the first segment of the content that is equal in length to the delivery time difference calculated by use of the formula (4) The transmission rate for delivery is changed from channel to channel, such that the rates of the channels are set equal to the bit rate of the content moving pictures, 2 times the bit rate, 4 times the bit rate, and so on, respectively. In the example illustrated in FIG. 4A, the transmission rate of the fifth channel (5ch) is set equal to the bit rate, and the transmission rate of the sixth channel (6ch) is set equal to twice the bit rate, for the delivery of the start portion.

### <6.4> Calculation of Delivery Commencement Timing of Channels for Delivering Start Portion

The delivery schedule pattern is created such that the delivery commencement timing of the channel for delivering a start portion at the transmission rate equal to the content bit rate is displaced by ½ of the delivery time difference from the earliest content delivery timing. Further, the delivery commencement timing of the channel for delivering the start portion at twice the content bit rate is displaced by ¼ of the delivery time difference from the earliest content delivery timing. Further, the delivery commencement timing of the channel for delivering the start portion at four times the content bit rate is displaced by ⅛ of the delivery time difference from the earliest content delivery timing.

In the present embodiment, as illustrated in FIG. 4A, the fifth channel (5ch) starts delivering a start portion at the transmission rate equal to the content bit rate at the timing that is delayed by ½ of the delivery time difference (i.e., delayed by 15 minutes) from the first channel (1ch) that is the earliest content delivery channel. Further, the sixth channel (6ch) starts delivering the start portion at twice the content bit rate at the timing that is delayed by ¼ of the delivery time difference (i.e., delayed by 7 minutes and 30 seconds) from the first channel (1ch) that is the earliest content delivery channel. A channel for delivering a start portion continuously repeats the delivery of the same start portion without a gap between each delivery of the start portion.

### <7> Delivery of Video Content

A video delivery unit 11 retrieves delivery schedule information and channel information (B-7, B-8). The video delivery unit 11 has an embedded clock unit. When the embedded clock unit indicates that the delivery commencement time specified in the delivery schedule has arrived, the video delivery unit 11 retrieves the specified content file (B-9), and delivers the content through the multicast address or port number assigned to the specified channel (B-10).

At the time of content delivery, the amount of content transmitted in synchronization with clock cycles is adjusted by using the bandwidth multiplying factor specified in the delivery schedule and the timestamp of the content as a reference (PCR: Program Clock Reference in the case of MPEG2-TS). With this arrangement, the content stream is transmitted while controlling the transmission rate (B-11).

### <8> Transmission of Program Listing

A schedule transmission unit 12 retrieves the channel information, the delivery schedule information, and the content information (B-12, B-13, B-14), and generates a program listing indicative of programs to be broadcast, channels (i.e., multicast addresses) for the respective programs, and broadcast hours of the respective programs, followed by transmitting the program listing to a reception and playback unit 14 (B-15). A general Web server or the like may be used for such transmission.

### <8> Selection of Received Channel

At the reception apparatus (i.e., client), the above-noted program listing is referred to select a channel imposing the shortest wait time for the content of the viewer request based on the delivery schedule and the network bandwidth available for the reception apparatus. In FIG. 4B, triangular symbols indicate the positions of content playback commencement that are available for the reception apparatus (i.e., client).

In the case in which the client environment allows reception to be performed at the rate that is larger than or equal to the bit rate of content moving pictures and smaller than twice the bit rate, it is achievable to receive and play the content at any one of the time points indicated by the triangular symbols on the row (A). In the case in which the client environment allows reception to be performed at the rate that is larger than or equal to twice the bit rate and smaller than three times the bit rate, it is achievable to receive and play the content at any one of the time points indicated by the triangular symbols on the row (B). In the case in which the client environment allows reception to be performed at the rate that is larger than or equal to three times the bit rate, it is achievable to receive and play the content at any one of the time points indicated by the triangular symbols on the row (C).

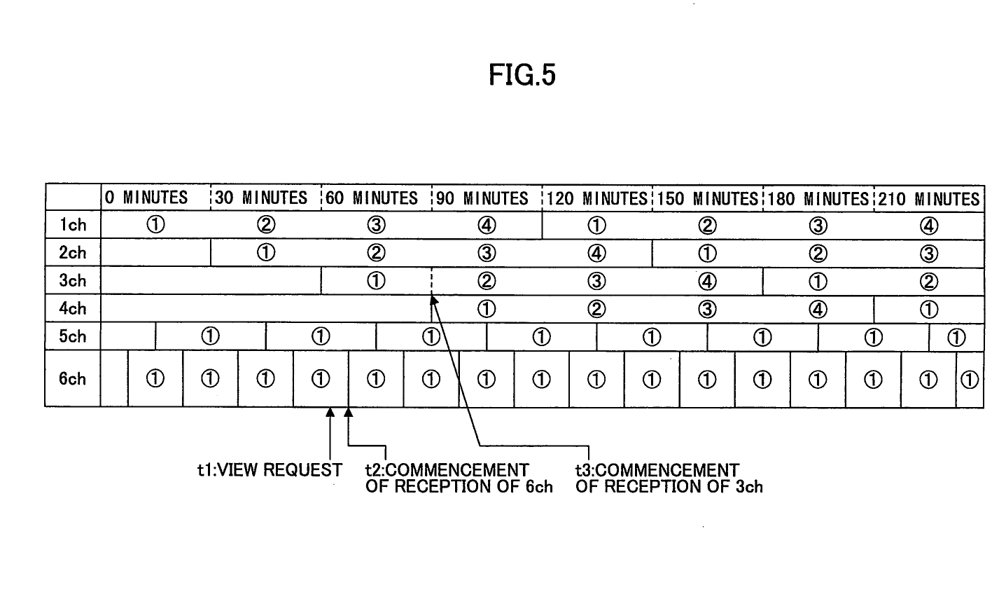

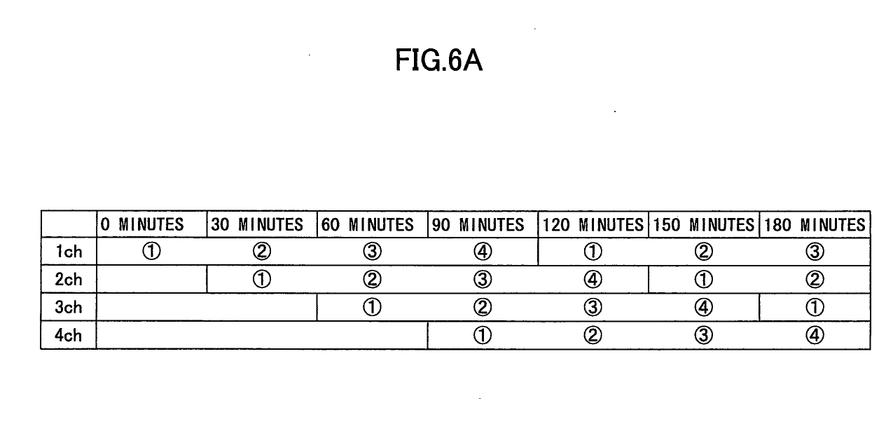

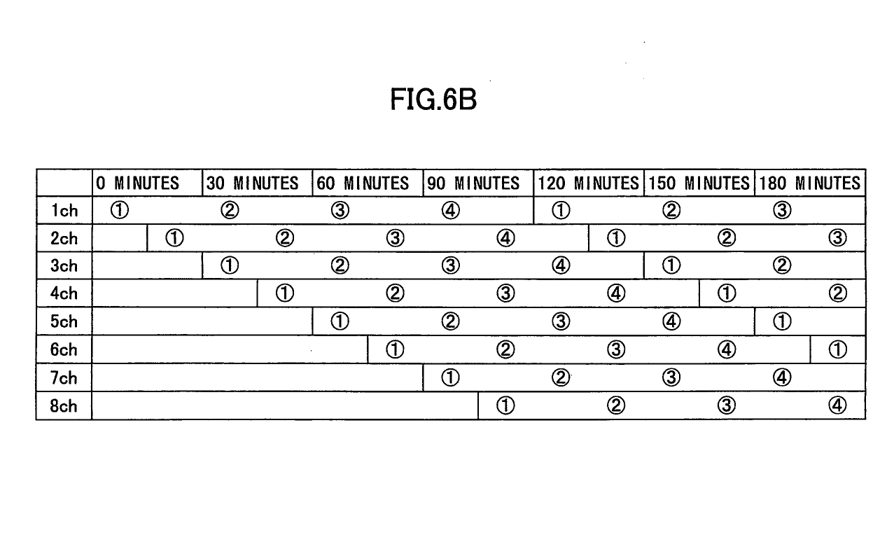

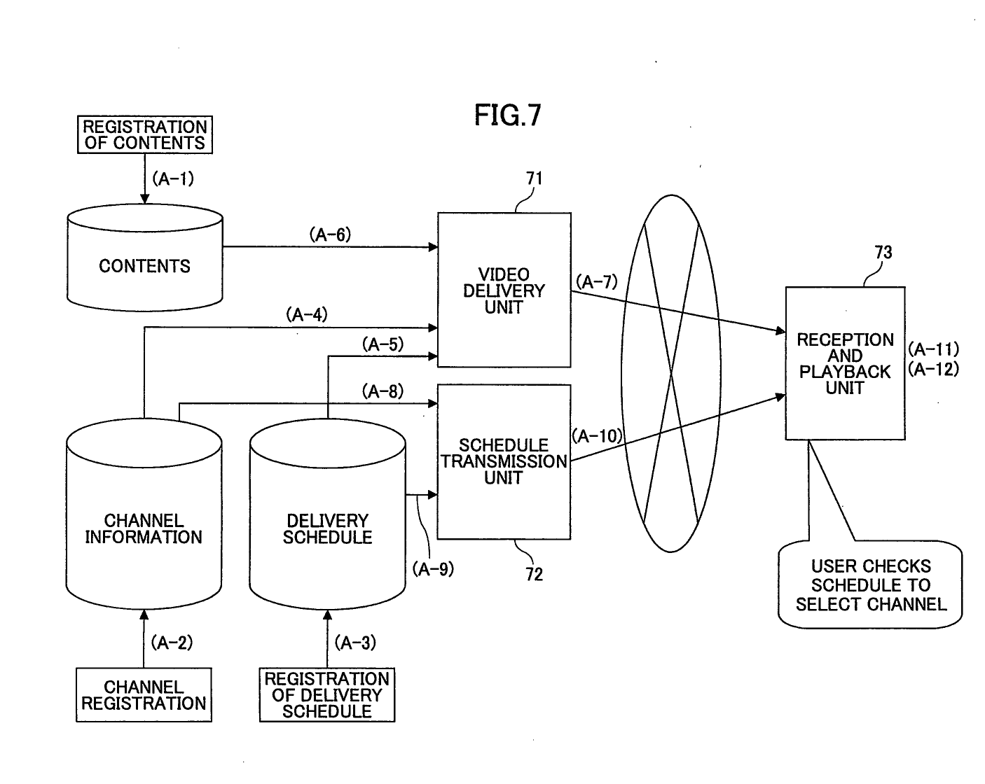

In the client environment that allows reception to be performed up to a 3-Mbps bandwidth, for example, the position of reception commencement at the reception apparatus may be set as illustrated in FIG. 5. In FIG. 5, upon a view request at time t1, for example, the start portion of the content (i.e., the first quarter of the content corresponding to the section indicated by encircled 1) delivered by the sixth channel is received and played from time t2 that is the time of the first delivery after time t1. Further, the subsequent portions of the content (i.e., the three quarters of the content corresponding to the sections indicated by encircled 2 through 4) delivered by the third channel is received and played from time t3 that is the time of the first delivery after time t2. In so doing, the content data of these subsequent portions is received through the third channel simultaneously with the playing of the start content portion received through the sixth channel.

In the delivery schedule example illustrated in FIG. 5, the first through fourth channels (1ch through 4ch) have bandwidths that are larger than or equal to the moving picture bit rate of the content and smaller than twice the moving picture bit rate. These first through fourth channels (1ch through 4ch) deliver the entirety of content with a 30-minute time difference between each channel delivery start time.

The fifth channel (5ch) has a bandwidth that is larger than or equal to the moving picture bit rate of the content and smaller than twice the moving picture bit rate. The fifth channel (5ch) delivers only the start portion (i.e., first quarter) of the content with a ½ of the above-noted time difference (i.e., 15 minutes) from the delivery commencement time of the first channel (1ch). The fifth channel (5ch) continuously repeats the delivery of the same start portion without a gap between each delivery of the start portion.

The sixth channel (6ch) has a bandwidth that is larger than or equal to twice the moving picture bit rate of the content and smaller than four times the moving picture bit rate. The sixth channel (6ch) delivers only the start portion (i.e., first quarter) of the content at twice the moving picture bit rate of the content with a ¼ of the above-noted time difference (i.e., 7 minutes and 30 seconds) from the delivery commencement time of the first channel (1ch). The sixth channel (6ch) continuously repeats the delivery of the same start portion without a gap between each delivery of the start portion.

Reception starts by use of the channel that delivers the start portion for the first time after time t1 at which a viewer request occurred. If this channel is one of the first through fourth channels (1ch through 4ch), the content continues to be received and played through the same channel.

The channel that delivers the start portion for the first time after time t1 at which a viewer request occurred may be the fifth channel (5ch), for example. In this case, the fifth channel (5ch) is used to receive and play the start portion. Further, the subsequent portions of the content (i.e., the three quarters of the content corresponding to the sections indicated by encircled 2 through 4) are received and played through the channel that delivers the portion immediately following the start portion (i.e., section indicated by encircled 2) during the reception and playback of the start portion. In this case, the content data are received simultaneously through two channels, so that it suffices for the network environment of the reception apparatus to have a bandwidth that is twice the content bit rate.

The channel that delivers the start portion for the first time after time t1 at which a viewer request occurred may be the sixth channel (6ch), for example. In this case, the sixth channel (6ch) is used to receive and play the start portion. Further, the subsequent portions of the content (i.e., the three quarters of the content corresponding to the sections indicated by encircled 2 through 4) are received and played through the channel that delivers the portion immediately following the start portion (i.e., section indicated by encircled 2) for the first time after the start of reception of the start portion.

In this case, the content data may be received simultaneously through two channels, i.e., one channel having a delivery rate equal to the bit rate of content moving pictures and the other channel having a delivery rate that is twice the bit rate. Accordingly, it suffices for the network environment of the reception apparatus to have a bandwidth that is three times the content bit rate.

With the arrangement described above, the longest wait time is shortened to a ¼ of the content delivery time difference between the channels for delivering the entirety of content (i.e., shortened to 7 minutes and 30 seconds) while using only 6 channels. With respect to the related-art configuration disclosed in Japanese Patent No. 3320976, an example in which a 120-minute content is delivered with the maximum wait time equal to 7 minutes and 30 seconds may be applied to provide the same wait time before the start of buffering. In this case, the related-art configuration requires 8 channels, while the present embodiment allows delivery to be properly performed by use of 6 channels, thereby achieving a reduction by 2 channels.

In a near-video-on-demand system, one or more channels dedicated for delivering a start portion of content at a bandwidth equal to the content bit rate or two or more times the content bit rate are provided. With this arrangement, an increase in the number of channels (i.e., number of multicast addresses) for content delivery is kept to a minimum number while shortening a wait time preceding commencement of viewing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method of delivering and playing content in a video-on-demand system, comprising:
delivering, through first-group channels, an entirety of the content at a delivery rate equal to a moving picture bit rate of the content with a time difference between each delivery commencement;
delivering, through one or more second-group channels different from the first-group channels, only a start portion of the content at a delivery rate equal to two or more times the moving picture bit rate of the content;
selecting, from the first-group channels and the one or more second-group channels, a channel through which the start portion of the content is received earliest after an occurrence of a view request, followed by receiving and playing the start portion through the selected channel; and
selecting, after receiving the start portion through the selected channel that is one of the one or more second-group channels, one of the first-group channels through which a remainder of the content following the start portion is received for a first time after a start of the reception of the start portion, followed by receiving and playing the remainder of the content through the selected one of the first-group channels.

2. The method as claimed in claim 1, wherein a different one of the first-group channels and the one or more second-group channels has a different delivery commencement time.

3. The method as claimed in claim 1, wherein the second-group channels further include an additional channel, and the method further comprises delivering, through the additional channel, only the start portion of the content at a delivery rate equal to the moving picture bit rate of the content.

4. The method as claimed in claim 3, wherein a different one of the first-group channels and the second-group channels has a different delivery commencement time.

5. The method as claimed in claim 3, wherein a different one of the second-group channels has a different delivery rate.

6. A transmission apparatus in a video-on-demand system, comprising:
a whole-content delivery unit configured to deliver, through first-group channels, an entirety of content at a delivery rate equal to a moving picture bit rate of the content with a time difference between each delivery commencement; and
a start portion delivery unit configured to deliver, through one or more second-group channels different from the first-group channels, only a start portion of the content at a delivery rate equal to two or more times the moving picture bit rate of the content.

7. The transmission apparatus as claimed in claim 6, wherein a different one of the first-group channels and the one or more second-group channels has a different delivery commencement time.

8. The transmission apparatus as claimed in claim 6, wherein the second-group channels further include an additional channel, and the start portion delivery unit is further configured to deliver, through the additional channel, only the start portion of the content at a delivery rate equal to the moving picture bit rate of the content.

9. The transmission apparatus as claimed in claim 8, wherein a different one of the first-group channels and the second-group channels has a different delivery commencement time.

10. The transmission apparatus as claimed in claim 8, wherein a different one of the second-group channels has a different delivery rate.

11. A reception apparatus in a video-on-demand system, comprising:
a start portion reception and playback unit configured to select, from first-group channels and one or more second-group channels, a channel through which a start portion of content is received earliest after an occurrence of a view request, and to receive and play the start portion through the selected channel, the first-group channels delivering an entirety of the content at a delivery rate equal to a moving picture bit rate of the content with a time difference between each delivery commencement, and the one or more second-group channels delivering only the start portion of the content at a delivery rate equal to two or more times the moving picture bit rate of the content; and
a remainder reception and playback unit configured to select, after receiving the start portion through the selected channel that is one of the one or more second-group channels, one of the first-group channels through which a remainder of the content following the start portion is received for a first time after a start of the reception of the start portion, and to receive and play the remainder of the content through the selected one of the first-group channels.

12. The reception apparatus as claimed in claim 11, wherein a different one of the first-group channels and the one or more second-group channels has a different delivery commencement time.

13. The reception apparatus as claimed in claim 11, wherein the second-group channels further include an additional channel which delivers only the start portion of the content at a delivery rate equal to the moving picture bit rate of the content.

14. The reception apparatus as claimed in claim 13, wherein a different one of the first-group channels and the second-group channels has a different delivery commencement time.

15. The reception apparatus as claimed in claim 13, wherein a different one of the second-group channels has a different delivery rate.
